(19) United States
(12) Patent Application Publication
(10) Pub. No.: US 2025/0178832 A1
(43) Pub. Date: Jun. 5, 2025

(54) WASTE COLLECTION VEHICLE

(71) Applicant: Shu-Pak Equipment Inc., Cambridge (CA)

(72) Inventors: David R. TANNER, Cambridge (CA); Keven P. ELLIS, Cambridge (CA)

(21) Appl. No.: 18/964,038

(22) Filed: Nov. 29, 2024

Related U.S. Application Data
(60) Provisional application No. 63/604,490, filed on Nov. 30, 2023.

(51) Int. Cl. B65F 3/08; B65F 3/02

(52) U.S. Cl. CPC B65F 3/08; B65F 2003/0243

(57) ABSTRACT

A waste collection vehicle for collection of right side and left side waste streams that respectively include right side and left side waste materials. The waste collection vehicle includes right and left side bodies, movable between respective raised and lowered positions. The right and left side bodies define respective right side and left side body compartments. The waste collection vehicle includes a hopper defining right and left hopper compartments. The right hopper compartment and the right side body compartment define a right side waste stream channel and the left hopper compartment and the left side body compartment define a left side waste stream channel. The right side and left side waste stream channels are sealed from each other, preventing cross-contamination of the right side and the left side waste material.

### CROSS-REFERENCE TO RELATED APPLICATION

This application claims priority from U.S. Provisional Patent Application No. 63/604,490, filed on Nov. 30, 2023, the entire disclosure whereof is hereby incorporated by reference herein.

### FIELD OF THE INVENTION

The present invention is a waste collection vehicle.

### BACKGROUND OF THE INVENTION

As is well known in the art, a waste collection vehicle for collecting municipal solid waste and recyclables typically is driven along one or more predetermined collection routes over a working day. The route is planned based on estimates of travel time, the time spent at each location to collect the material, and the time required to be spent to unload the material at a suitable location. Appropriate allowance is made for contingencies, so that the vehicle and the worker(s) can complete an assigned collection route in a working day.

Electric vehicles have been developed for use in municipal waste collection. However, to date, electric waste collection vehicles have not had sufficient range for use on a typical collection route. In general, energy consumption is too high in relation to battery energy capacity, and as a result, the prior art electric waste collection vehicle is required to return to its home base for recharging before the route is completed. This means that the conventional electric waste collection vehicles are generally impractical and/or inefficient.

It has been found that a significant portion of the energy consumed is used in raising a conventional waste collection vehicle's body portion, to empty it of the collected material. Peak energy consumption occurs when the vehicle is at the disposal site, emptying compartments in its body portion of the waste collected.

In the typical electric waste collection vehicle, the body portion includes a hopper into which the waste material is introduced (e.g., from carts), and compartments positioned rearwardly from the hopper into which the waste material is pushed by a packer ram. Because of the typical unitary construction of the hopper and the compartments into which the waste material from the hopper is pushed, it is necessary to raise the entire body portion (i.e., the hopper and the rear compartments into which the waste material has been pushed) in order to empty the rear compartments, and the peak energy consumption takes place at this time.

Conventional two-stream sideloading waste collection vehicles that are built for receiving refuse and recyclables typically include two channels therein, intended for receiving the refuse and the recyclables respectively, or for receiving two different types of recyclables. However, in the prior art, the two channels are not completely separated from each other. As a result, in the conventional waste collection vehicle, there can be significant cross-contamination of the materials that are received in the two channels.

For example, in the conventional waste collection vehicle, a body portion of the vehicle typically includes compartments of the two channels, into which the refuse and recyclable material are pushed. The refuse and recyclable material are initially discharged into a hopper, in which the refuse and recyclable material, under the influence of gravity, is directed into the two respective channels. The material is moved into one of two compartments in the body portion. The conventional vehicle typically includes a single packer ram, with a ram front face mounted to a hydraulic actuator that is positioned to push such material as is located in the compartments that are in the body portion toward the rear end of the vehicle, and also to compress the material.

As is well known in the art, the waste collection vehicle typically includes a guide assembly for guiding the single packer ram as the ram is moved between its retracted and extended conditions.

Typically, the ram plate of the single packer ram is formed to push material through both of the two compartments in the body portion toward the rear end of the vehicle, simultaneously. However, because the same ram plate is moved through the two compartments at the same time, the two compartments are not sealed from each other. This arrangement results in significant cross-contamination of the materials positioned in the two body portion compartments.

For instance, if refuse is positioned in one body portion compartment and recyclable material is positioned in the other body portion compartment, when these two different types of waste are engaged by the same ram plate at the same time, there tends to be some cross-contamination of the refuse and the recyclable materials. This is because, at the edges of the ram plate, the two compartments are in fluid communication with each other.

Also, because there typically is only one packer ram, the ram plate may have different loads to push against simultaneously in the two body portion compartments, resulting in significant wear issues. For example, depending on the circumstances, there may be material located only in one compartment, and no material located in the other compartment. Or, if there is material to push in both body portion compartments, then there may be more material, or more dense material, or material that is adhering to the floor or walls of the compartment, in one of the compartments. As a result, the guide assembly in a conventional waste collection vehicle, and in particular guide shoes thereof, are typically subjected to substantial wear. Due to such wear, substantial replacement and repair costs are routinely incurred.

### SUMMARY OF THE INVENTION

For the foregoing reasons, there is a need for a waste collection vehicle that overcomes or mitigates one or more of the defects or deficiencies of the prior art.

In its broad aspect, the invention provides a waste collection vehicle for collection of separate waste streams that include right side and left side waste material. The waste collection vehicle includes a right side body mounted to a frame and movable between raised and lowered positions thereof. The right side body defines a right side body compartment therein extending between right intake and right output ends thereof. The right side body also defines a right side intake opening at the right side intake end, and a right output opening at the right output end.

The waste collection vehicle also includes a left side body mounted to the frame and movable between raised and lowered positions thereof. The left side body defines a left side body compartment extending between left intake and left output ends thereof. The left side body also defines a left intake opening at the left intake end and a left output opening at the left output end.

The intake openings are alternately closed and opened by respective right and left intake door assemblies. The output openings also are alternately closed and opened by respective right and left output door assemblies.

The waste collection vehicle also includes a hopper defining right and left hopper compartments therein, wherein the right hopper compartment and the right side body compartment define a right side waste stream channel to receive the right side waste stream when the right side body is in the lowered position thereof and the right intake opening is open, and the left hopper compartment and the left side body compartment define a left side waste stream channel to receive the left side waste stream when the left side body is in the lowered position thereof and the left intake opening is open. The right side and left side wast stream channels are sealed from each other to prevent cross-contamination of the right side and left side waste material.

### BRIEF DESCRIPTION OF THE DRAWINGS

The invention will be better understood with reference to the attached drawings, in which:

FIG. 1A is an isometric view of an embodiment of the waste collection vehicle of the invention;

FIG. 1B is an isometric view of an embodiment of a cart tipper of the invention, drawn at a larger scale;

FIG. 2A is an isometric view of a portion of the cart tipper of FIG. 1B;

FIG. 2B is an isometric view of right side and left side waste stream channels inside right and left bodies and a hopper of the waste collection vehicle of FIG. 1A, drawn at a smaller scale;

FIG. 3A is a top view of the right side and left side waste stream channels, showing right side and left side waste carts positioned for emptying into the right side and left side waste stream channels respectively;

FIG. 3B is another top view of the right side and left side waste stream channels;

FIG. 3C is an isometric view of the rights side and left side waste stream channels;

FIG. 3D is another isometric view of the right side and left side waste stream channels;

FIG. 3E is a top view showing right side and left side packer ram assemblies;

FIG. 3F is another top view showing the right side and left side packer ram assemblies;

FIG. 4 is an isometric view of respective right and left intake ends of the right and left bodies, drawn at a larger scale;

FIG. 5 is another isometric view of the waste collection vehicle of FIG. 1A, drawn at a smaller scale;

FIG. 6A is an isometric view of a portion of the waste collection vehicle in which a right side body is in a raised position and a left side body is in a lowered position thereof, drawn at a larger scale;

FIG. 6B is another isometric view of a portion of the waste collection vehicle of FIG. 6A, in which the right side body is in the raised position and the left side body is in the lowered position;

FIG. 7A is an isometric view of a portion of the waste collection vehicle in which the left side body is in a raised position and the right side body is in a lowered position thereof; and

FIG. 7B is another isometric view of a portion of the waste collection vehicle of FIG. 7A, in which the left side body is in the raised position and the right side body is in the lowered position.

### DETAILED DESCRIPTION

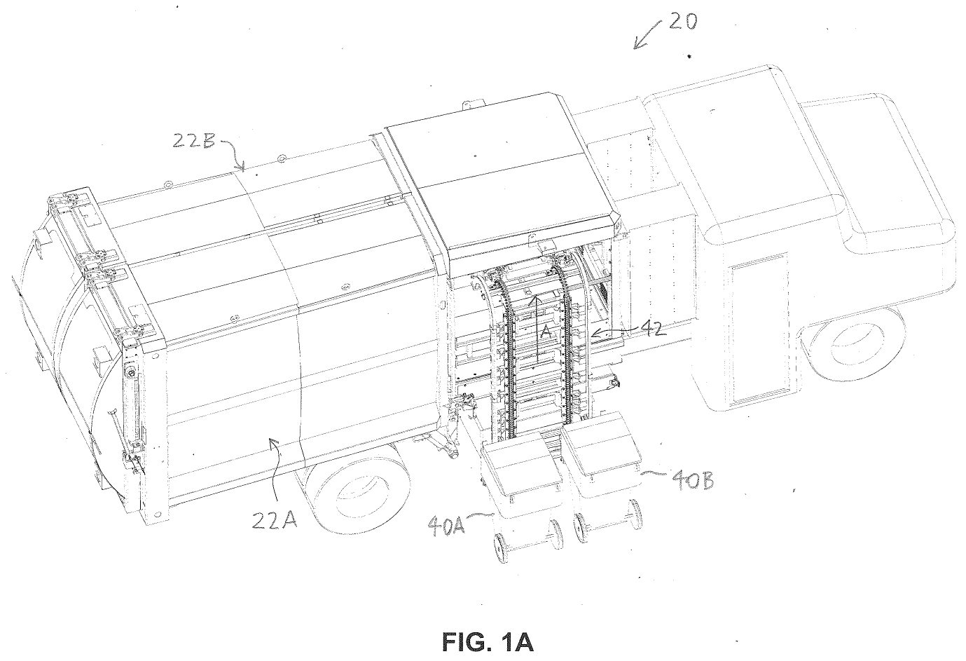

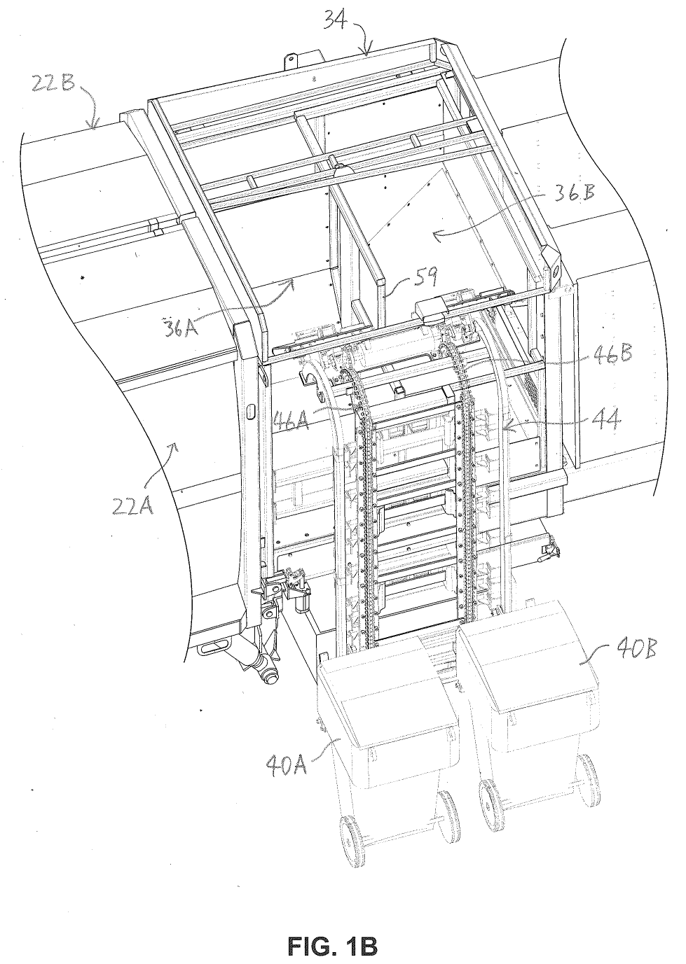

In the attached drawings, like reference numerals designate corresponding elements throughout. Reference is made to FIGS. 1A-7B to describe an embodiment of a waste collection vehicle in accordance with the invention indicated generally by the numeral 20.

It will be understood that, for the purposes hereof, “waste” may include (i) refuse (i.e., household garbage, to be directed to a landfill) and (ii) recyclables. It will also be understood that “recyclables” may include different types of recyclables, for example:
glass recyclables (e.g., household items such as glass bottles and jars);
metal recyclables (e.g., household items such as food cans and soda cans);
plastic recyclables (e.g., household items such as bottles, jars, and consumer packaging); and
fiber and cardboard recyclables (e.g., household items such as paper, cardboard, and consumer packaging).

Those skilled in the art would appreciate that the different types of recyclables preferably are kept separate from each other. From the foregoing, it can be seen that there may be several different streams of recyclable material to be collected, and kept separate from each other, depending on the circumstances.

As will be described, the waste collection vehicle 20 is for collection of right side and left side waste streams that include right side and left side waste stream material respectively. The right side and left side waste stream materials are preselected. For instance, the right side and left side waste stream material may be (i) refuse material, and (ii) a type of recyclable material respectively. However, the right side and left side waste stream material in the right side and left side waste streams may instead be two different types of recyclable materials, as noted above.

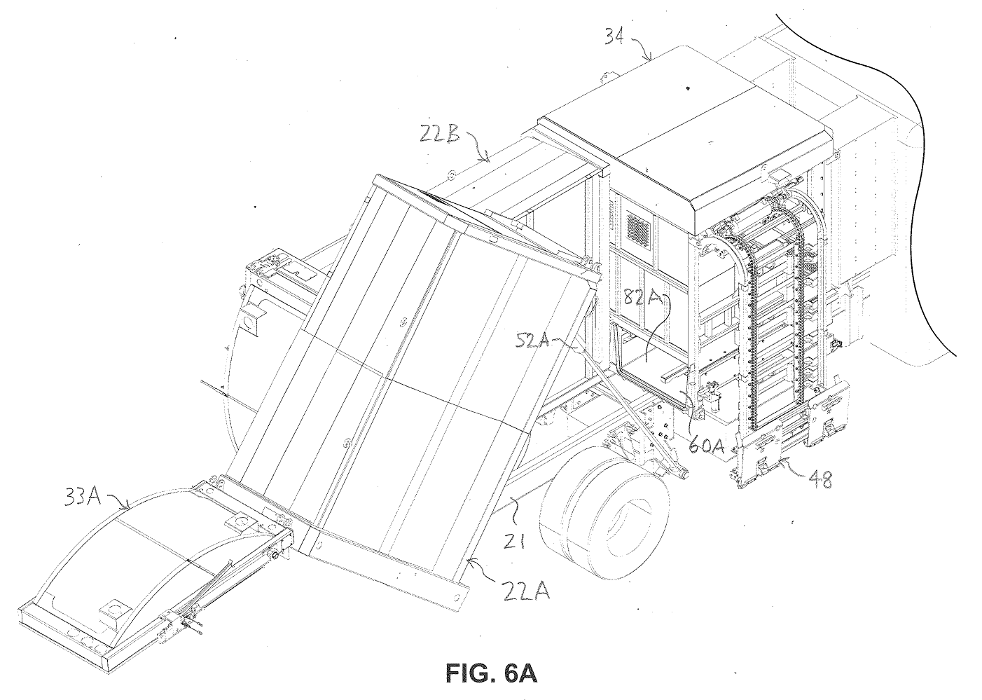

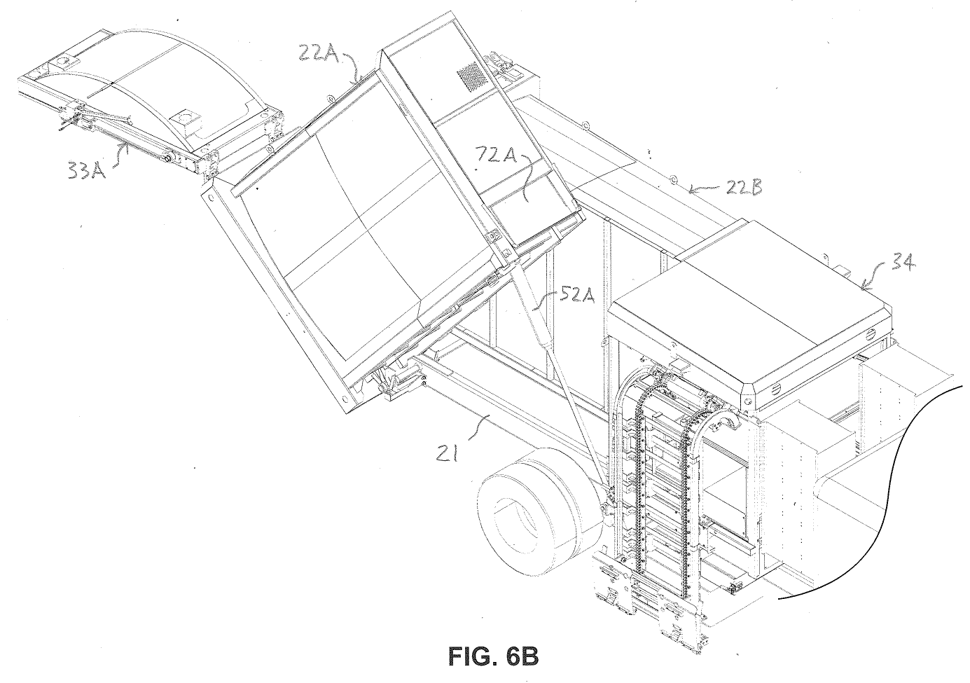

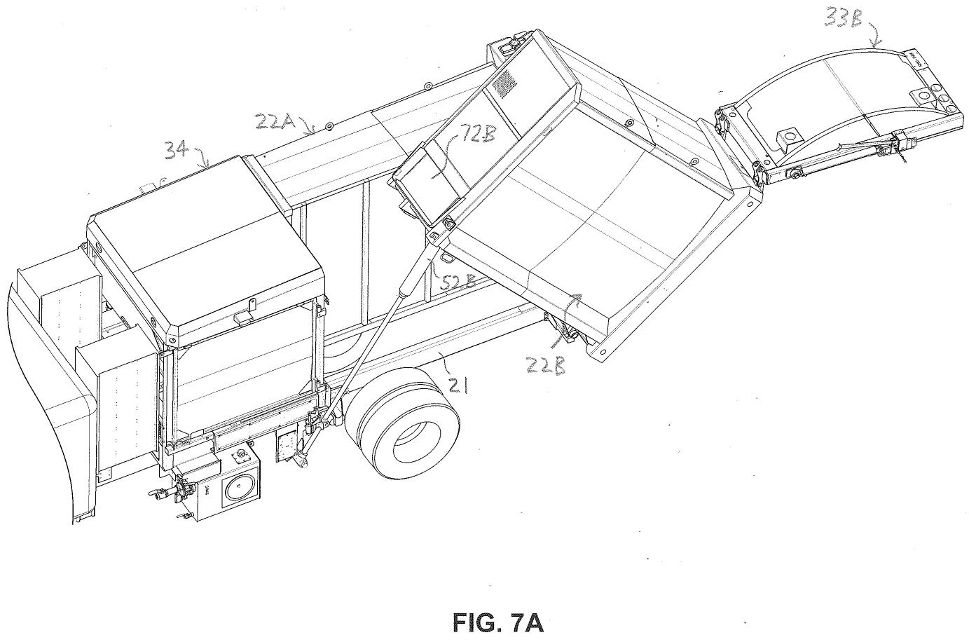

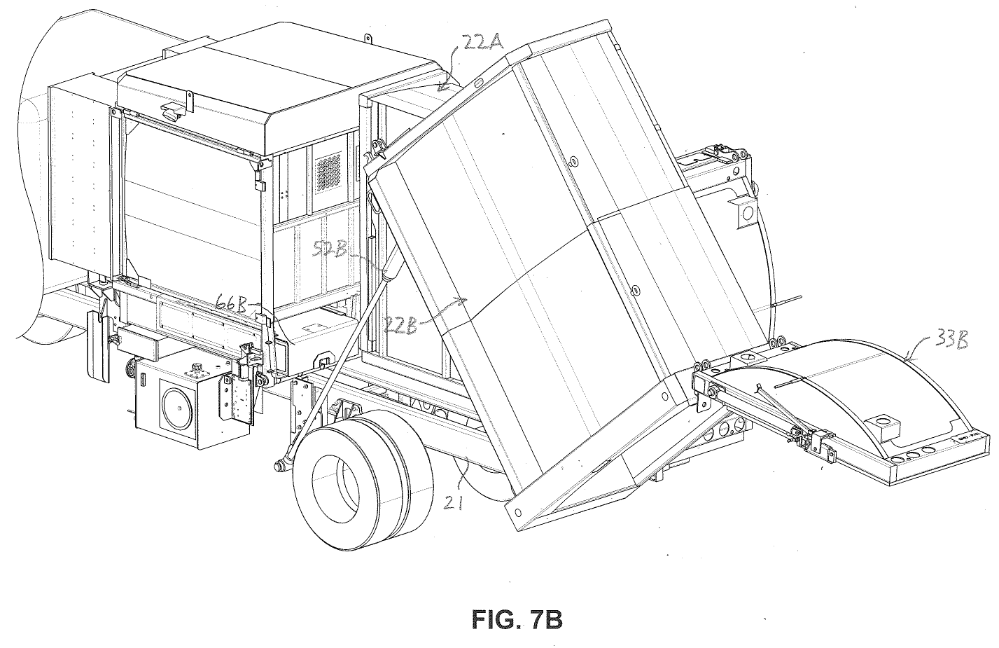

The waste collection vehicle may be electric, or it may be powered by an internal combustion engine, or it may be a combination thereof. In one embodiment, the waste collection vehicle 20 preferably includes a right side body 22A mounted to a frame 21 (FIGS. 6A, 6B). The right side body 22A preferably is movable between raised and lowered positions thereof. For example, in FIGS. 6A and 6B, the right side body 22A is shown in its raised position, and in FIGS. 7A and 7B, the right side body 22A is shown in its lowered position. The right side body 22A preferably defines a right side body compartment 24A extending between right intake and right output ends 26A, 28A thereof.

Preferably, the waste collection vehicle 20 also includes a left side body 22B mounted to the frame 21 (FIGS. 7A, 7B) and movable between raised and lowered positions thereof. In FIGS. 7A and 7B, the left side body 22B is shown in its raised position, and in FIGS. 6A and 6B, the left side body 22B is shown in its lowered position. The left side body 22B preferably defines a left side body compartment 24B extending between left intake and left output ends 26B, 28B thereof.

As can be seen in FIGS. 6A-7B, in one embodiment, only one of the right side and left side bodies 22A, 22B may be raised at one time. It will be understood that, while a selected one of the right side and left side bodies is moved from its lowered position to its raised position, and also moved from its raised position to its lowered position, the other (non-raised) body remains in its lowered position.

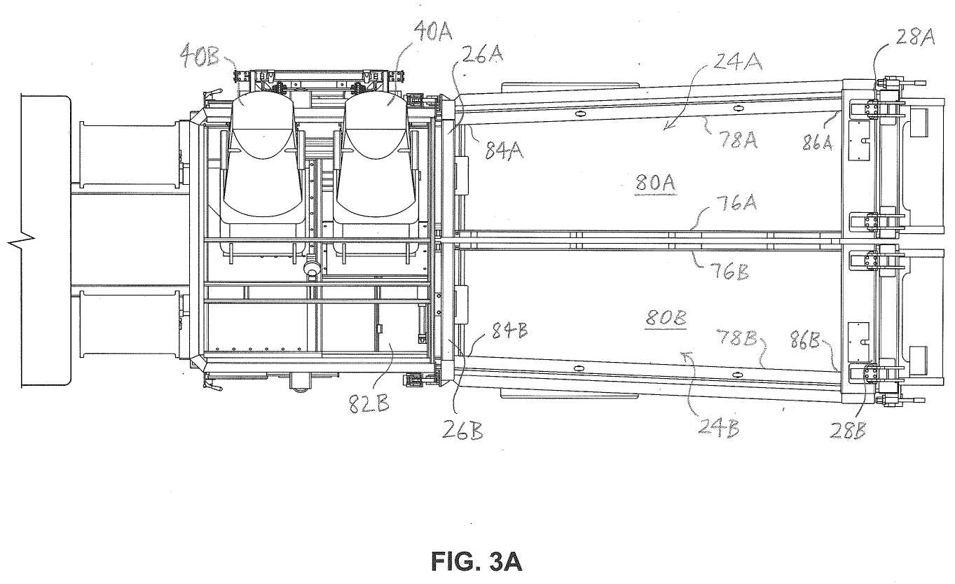

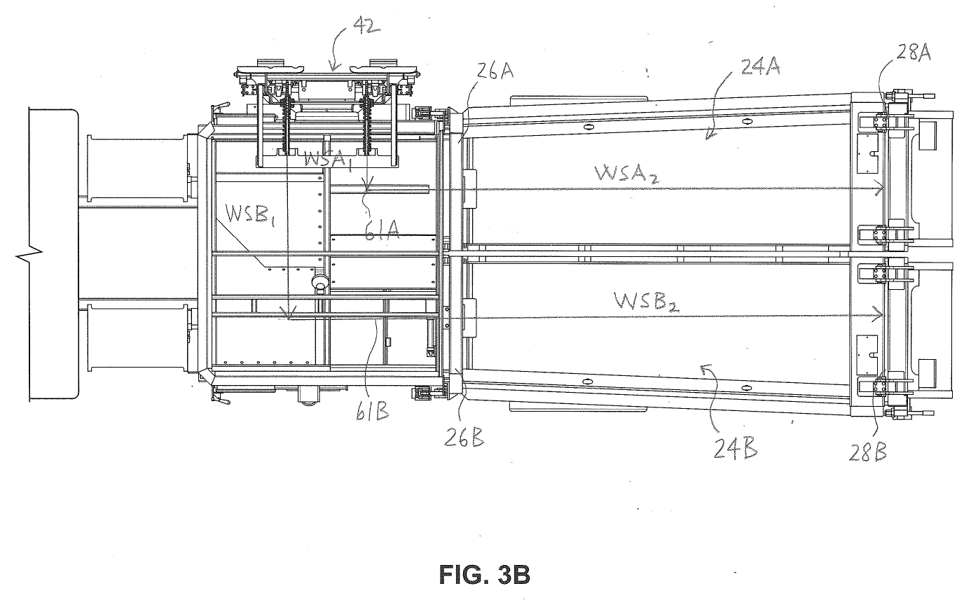

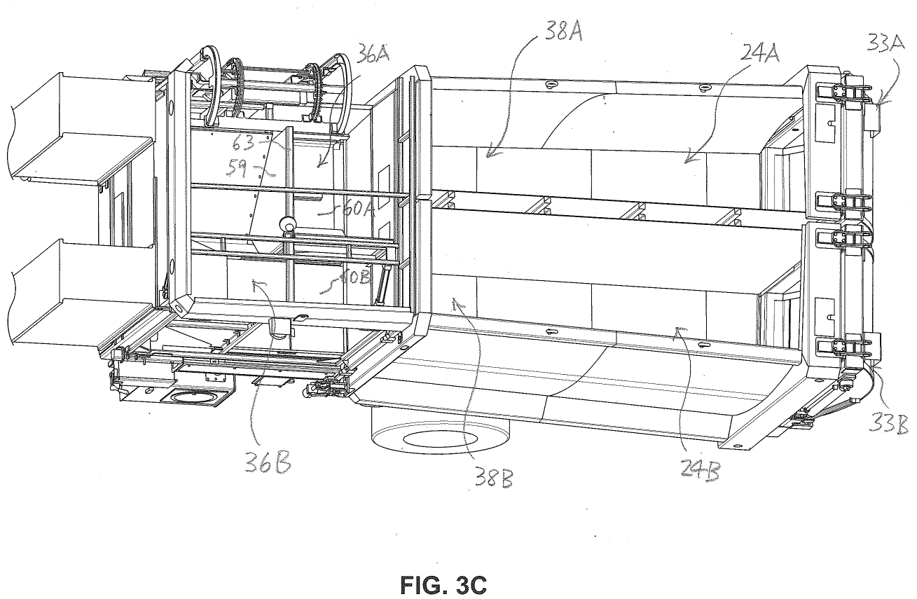

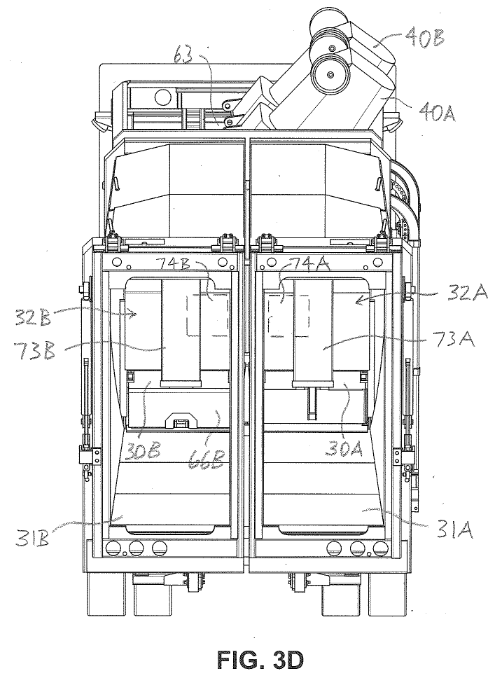

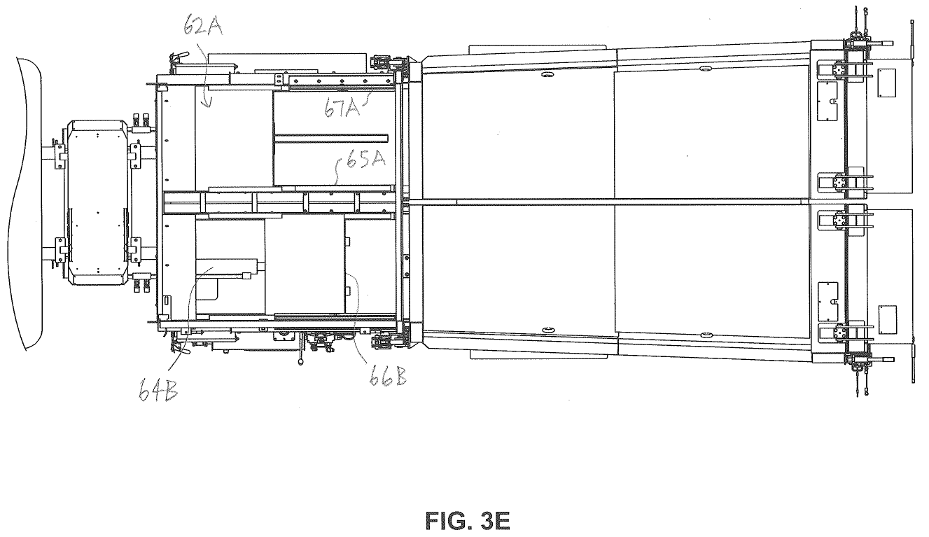

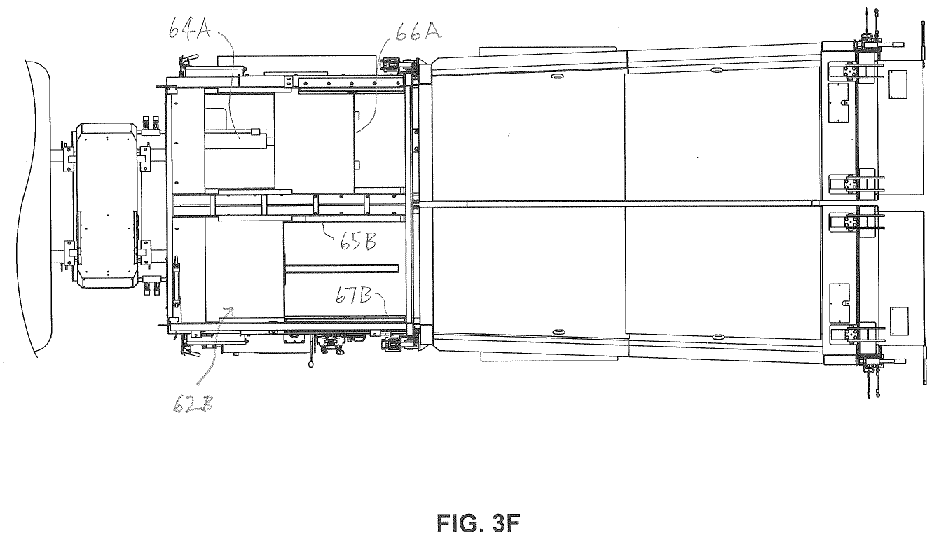

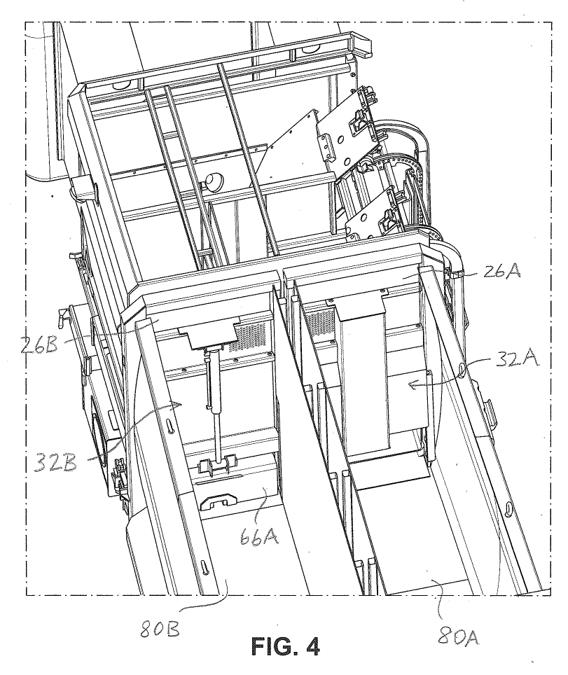

As can be seen in FIGS. 3A, 3B, 3D, and 4, it is preferred that the right side body 22A defines a right intake opening 30A at the right intake end 26A, and a right output opening 31A at the right output end 28A. The left side body 22B also preferably defines a left intake opening 30B at the left intake end 26B, and a left output opening 31B at the left output end 28B.

In one embodiment, the system 20 preferably also includes a right intake door assembly 32A and a right tailgate assembly 33A, for closing and opening the right intake opening 30A and the right output opening 31A respectively (FIGS. 3C, 3D, 4). Preferably, the system 20 also includes a left intake door assembly 32B and a left tailgate assembly 33B, for closing and opening the left intake opening 30B and the left output opening 31B respectively (FIGS. 3C, 3D, 4).

As will be described, when (i) the right side body 22A is in its lowered position, (ii) the right intake opening 30A is open, and (iii) the right output opening 31A is covered or closed, the right side waste stream may be positioned in right side body compartment 24A. Similarly, when (i) the left side body 22B is in its lowered position, (ii) the left intake opening 30B is open, and (iii) the left output opening 31B is covered or closed, the left side waste stream may be positioned in the left side body compartment 24B.

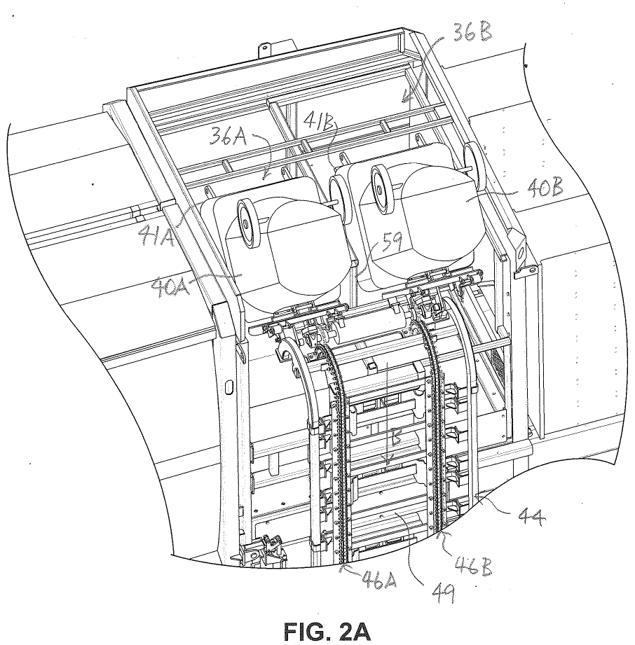

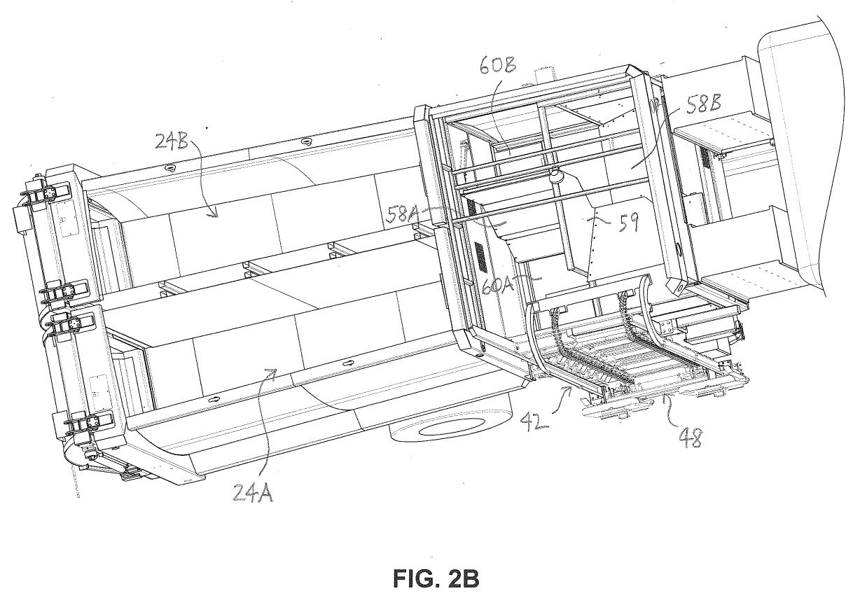

The waste collection vehicle 20 preferably includes a hopper 34 (FIGS. 1B-3C). Preferably, the hopper 34 defines right and left hopper compartments 36A, 36B therein (FIGS. 1B, 2B). The right side and left side waste streams are first received in the vehicle 20 in the hopper 34.

The right hopper compartment 36A and the right side body compartment 24A define a right side waste stream channel 38A, for receiving the right side waste stream when the right side body 22A is in the lowered position thereof and the right intake opening 30A is open. Similarly, the left hopper compartment 36B and the left side body compartment 24B define a left side waste stream channel 38B, for receiving the left side waste stream when the left side body 22B is in the lowered position thereof and the left intake opening 30B is open. As will also be described, the right side and left side waste stream channels 38A, 38B are sealed from each other, to prevent cross-contamination of the right side and left side waste stream material that is positioned therein.

For clarity of illustration, the path of the waste material through the right side waste stream channel 38A is schematically indicated in FIG. 3B by arrows “WSA₁” and “WSA₂”. The path of the waste material through the left side waste stream channel 38B is schematically indicated in FIG. 3B by arrows “WSB₁” and “WSB₂”.

Preferably, the right side and left side waste stream material is provided inside respective right side and left side waste carts 40A, 40B (FIG. 1A). Those skilled in the art would be aware of suitable waste carts. As can be seen in FIGS. 1A, 2A, and 3A, the right side and left side waste carts 40A, 40B are engaged by a cart tipper 42 that lifts the right side and left side waste carts 40A, 40B to respective discharge positions, at which the right side and left side waste carts 40A, 40B are tipped to discharge, under the influence of gravity, the right side and left side waste stream material therein into the right side and left side waste stream channels 38A, 38B respectively.

As noted above, when the vehicle 20 is configured for receiving the right side and left side waste streams in the hopper 34, the right side and left side bodies 22A, 22B are in their lowered positions (FIG. 1A). Also, the right and left intake openings 30A, 30B are open at this time, and the right and left output openings 31A, 31B are respectively covered or closed by the right and left output door assemblies 33A, 33B.

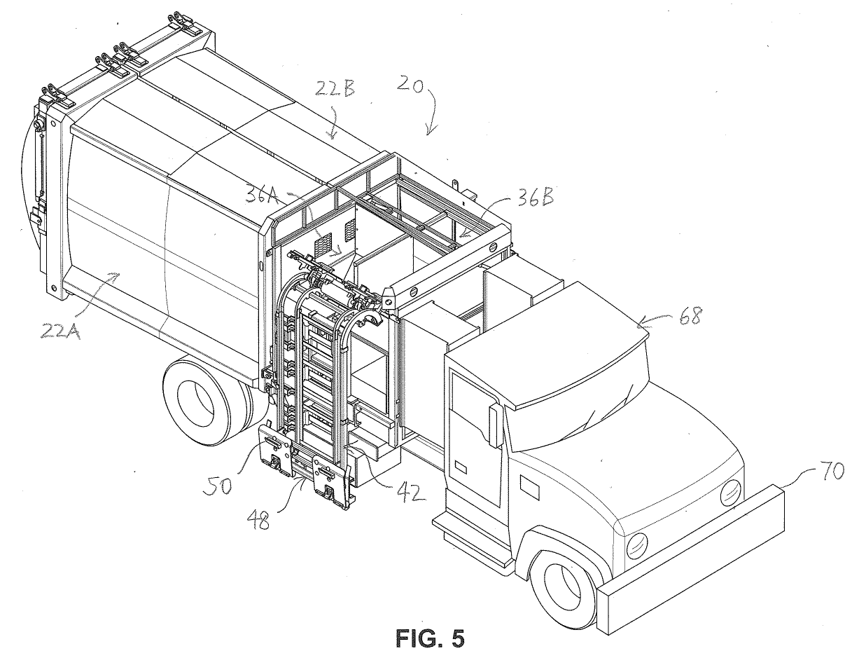

As can be seen in FIGS. 1B and 2A, in one embodiment, the cart tipper 42 preferably includes cart tipper guide rails 44 and cart tipper tracks 46A, 46B mounted to the cart tipper rails 44. The cart tipper 42 preferably also includes a cart tipper carriage 48 mounted to the tracks 46A, 46B on which the carriage 48 preferably may travel between a load position (FIGS. 1A, 1B, 5) and a discharge position (FIG. 2A).

In one embodiment, the cart tipper 42 preferably includes a plurality of support brackets 49 secured to the cart tipper guide rails 44 that secure the tracks 46A, 46B to each other. The support brackets 49 enable the cart tipper 42 to lift two waste carts 40A, 40B at the same time that include significantly different loads therein.

As is well known in the art, each of the carts 40A, 40B includes a fitting (not shown) that may be engaged with a cart grabber bracket 50 on the carriage subassembly 48 (FIG. 5), to secure the carts 40A, 40B to the carriage subassembly 48. Because the fittings on the carts 40A, 40B and the mating fittings are well known in the art, further description thereof is unnecessary.

It will be understood that the right side and left side waste carts 40A, 40B may be filled with right side and left side waste material respectively by a resident (not shown) and positioned by the resident at a predetermined location, e.g., at or near a curb. For instance, the right side waste cart 40A may have refuse material in it, and the left side waste cart 40B may have recyclable material in it. When the carriage subassembly 48 is in its load position, the fittings on the carts 40A, 40B are engageable with the respective cart grabber brackets 50 on the carriage subassembly 48. Once the carts 40A, 40B are secured to the carriage subassembly 48, the carriage subassembly 48 moves on the tracks 46A, 46B in the direction indicated by arrow “A” to the carriage subassembly's discharge position (FIG. 1B), carrying the carts 40A, 40B from the load position to the discharge position of the carriage subassembly 48. As can be seen in FIG. 2A, when the carriage subassembly 48 is in its discharge position, the right side and left side waste carts 40A, 40B secured thereto are upended, so that the contents thereof are discharged, under the influence of gravity, into the right and left hopper compartments 36A, 36B respectively.

As an example, if the right side waste cart 40A has refuse material positioned therein, then the refuse material is discharged into the right hopper compartment 36A. Similarly, recyclable material in the left side waste cart 40B is discharged into the left hopper compartment 36B.

Once the carts 40A, 40B have been emptied, the carriage subassembly 48 travels on the tracks 46A, 46B in the direction indicated by arrow “B” to return the carriage subassembly 48 to the carriage subassembly's load position (FIG. 2A). After the carriage subassembly 48 has been returned to its load position, the carts 40A, 40B are released therefrom (i.e., the fittings on the carts 40A, 40B are released from the cart grabber brackets 50 on the carriage subassembly 48) and positioned on the ground, and the vehicle 20 may move to another location.

Those skilled in the art would appreciate that on occasion the cart tipper may handle only one waste cart, i.e., where only one waste cart is provided. Because the carts 40A, 40B and the fittings used to secure the carts 40A, 40B to the carriage subassembly 46 are well known in the art, further description thereof is unnecessary.

It will be understood that the carts 40A, 40B may be raised and dumped into the hopper by any suitable means, and the cart tipper 42 is one such means. Alternatively, for example, an automated arm may be utilized for emptying the carts into the hopper.

The location to which the vehicle 20 is moved depends on whether one or both of the right and left body compartments 24A, 24B is in a filled condition. If neither of the right and left body compartments 24A, 24B is in a filled condition, then the vehicle is moved to a location at which more waste material, in more carts, is available, and the contents of the carts are respectively discharged into the hopper compartments 36A, 36B, as described above. Alternatively, if one or both of the right and left body compartments 24A, 24B are in a filled condition (as will be described), then the vehicle 20 preferably is moved to a disposal site (not shown), at which the right and left body compartments 24A, 24B are emptied.

For example, if one or both of the right and left body compartments 24A, 24B are in a filled condition, then the vehicle 20 may proceed to the disposal site, at which the bodies 22A, 22B may be raised separately, as illustrated in FIGS. 6A-7B, to discharge material from the right and left body compartments 24A, 24B respectively, as will be described. Those skilled in the art would appreciate that, at the disposal site, the waste is discharged from the right and left body compartments 24A, 24B at respective selected locations, according to the types of waste in the body compartments 24A, 24B.

For example, if the waste material in the right side body compartment 24A is refuse material, then at the disposal site, the vehicle 20 is positioned to locate the right output end 28A so that the refuse material in the right side body compartment 24A may be discharged therefrom at a location selected to receive refuse material. Once the vehicle 20 is in position, the right tailgate assembly 33A is opened, and the right side body 22A is raised to its raised position (FIGS. 6A, 6B), to allow the refuse material to exit from the right side body compartment 24A under the influence of gravity. Once the right side body compartment 24A is empty, the right side body 22A is moved to its lowered position, and the right tailgate assembly 33A is closed.

In order to discharge the waste material in the left side body compartment 24B, the vehicle 20 is positioned to locate the left output end 28B proximal to a location selected to receive the waste material that is in the left side body compartment 24B.

For example, if the waste material in the left side body compartment 24B is plastic recyclables, then the vehicle 20 is positioned to locate the left output end 28B so that the plastic recyclables in the left side body compartment 24B may be discharged therefrom at a location at the disposal site selected to receive plastic recyclables. Once the vehicle 20 is in position, the left tailgate assembly 33B is opened, and the left side body 22B is raised to its raised position (FIGS. 7A, 7B), to allow the plastic recyclables to exit from the left side body compartment 24B under the influence of gravity. Once the left side body compartment 24B is empty, the left side body 22B is moved to its lowered position, and the left tailgate assembly 33B is closed.

As can be seen in FIGS. 6A-7B, each of the right side and left side bodies 22A, 22B is moved between its lowered and raised positions by respective right side body and left side body hoist cylinders 52A, 52B. It will be understood that the movement of the right side and left side bodies 22A, 22B is completely independent.

It will also be understood that the vehicle 20 is configured to raise only a selected one of the right side and left side bodies 22A, 22B at one time.

In summary, after the waste material in the right and left body compartments 24A, 24B has been discharged at the disposal site, the right side and left side bodies 22A, 22B are both in their lowered positions. Also, the right side and left side output door assemblies 33A, 33B are closed, to cover the right and left output openings 31A, 31B. The vehicle 20 is then moved to the locations (hereinafter sometimes referred to as “intake locations”) at which the waste is to be picked up sequentially, where waste material from respective carts 40A, 40B is discharged into the right side waste stream and left side waste stream chutes 58A, 58B, as described above.

As can be seen in FIG. 2B, the right and left hopper compartments 36A, 36B preferably include a right side waste stream chute 58A and a left side waste stream chute 58B, and right side waste stream and left side waste stream lower hopper compartments 60A, 60B. When waste is discharged into the right and left hopper compartments 36A, 36B, the waste initially falls into the right side waste stream and left side waste stream chutes 58A, 58B, and under the influence of gravity, the waste then moves from the right side waste stream and left side waste stream chutes 58A, 58B into the right side waste stream and left side waste stream lower hopper compartments 60A, 60B respectively. When the bodies 22A, 22B are in their respective lowered positions, the right side waste stream and left side waste stream lower hopper compartments 60A, 60B are aligned with the right and left body compartments 24A, 24B respectively.

Those skilled in the art would appreciate that, before the right side and left side waste streams are introduced into the right side waste stream and left side waste stream chutes 58A, 58B, a number of conditions preferably are met. As noted above, the right side and left side bodies 22A, 22B are in their lowered positions, and the right and left output openings 31A, 31B are covered or closed by the right side and left side output door assemblies 33A, 33B. Also, the right and left intake openings 30A, 30B are open, so that the waste material that is located in the right side waste stream and left side waste stream lower hopper compartments 60A, 60B may be pushed into the right and left body compartments 24A, 24B, as will be described.

In FIGS. 1B, 2A, 2B, and 3C, it can be seen that the right side waste stream and left side waste stream chutes 58A, 58B preferably are separated from each other by a chute divider wall 59. It will be understood that, when each of the carts 40A, 40B is discharged into the right side waste stream and left side waste stream chutes 58A, 58B, upper ends 41A, 41B of the respective carts 40A, 40B are located below a top end 63 of the chute divider wall 59 (FIGS. 3C, 3D). In this way, when the waste material is discharged into the right side waste stream and left side waste stream chutes 58A, 58B, the two waste streams are kept separate from each other, because the chute divider wall 59 prevents the two waste streams from mixing together.

It will be understood that the right side waste stream and left side waste stream chutes 58A, 58B are separated from each other (FIG. 2B) along the entire lengths of the right side waste stream and left side waste stream chutes 58A, 58B. The right side waste stream and left side waste stream lower hopper compartments 60A, 60B are also separated from each other along their entire lengths.

As can be seen in FIG. 3B, the waste material that exits from the right side waste stream and left side waste stream chutes 58A, 58B preferably lands in the right side waste stream and left side waste stream lower hopper compartments 60A, 60B at predetermined locations 61A, 61B therein.

It is preferred that the waste collection vehicle 20 additionally includes a right side packer ram assembly 62A, for pushing the right side waste stream material at least partially through the right side waste stream channel 38A toward the right output end 28A. The waste collection vehicle 20 preferably also includes a left side packer ram assembly 62B, for pushing the left side waste stream material at least partially through the left side waste stream channel 38B toward the left output end 28B.

As can be seen in FIGS. 3E and 3F, the right side packer ram assembly 62A preferably includes a right side actuator 64A connected to a right side ram face 66A. Similarly, the left side packer ram assembly 62B preferably includes a left side actuator 64B connected to a left side ram face 66B. It will be understood that the actuators 64A, 64B may be moved by any suitable means. In one embodiment, the actuators 64A, 64B preferably are moved by hydraulic cylinders.

It will also be understood that the right side and left side packer ram assemblies 62A, 62B are configured to function independently.

The packer ram assemblies 62A, 62B preferably are both movable between extended and retracted conditions thereof. For instance, the right side packer ram assembly 62A is shown in its retracted condition, and the left side packer ram assembly 62B is shown in its extended condition, in FIG. 3E. In FIG. 3F, the right side packer ram assembly 62A is shown in its extended condition, and the left side packer ram assembly 62B is shown in its retracted condition. It will be understood that a number of elements are omitted from certain of the drawings, such as FIGS. 3E and 3F, for clarity of illustration.

When the right side and left side packer ram assemblies 62A, 62B are in the respective extended conditions thereof, the rams 64A, 64B are extended to locate the respective ram faces 66A, 66B at preselected locations in the right and left body compartments 24A, 24B.

From the foregoing, it can be seen that, before the right side and left side waste stream material is positioned in the right side and left side waste stream channels 38A, 38B, each of the right side and left side packer ram assemblies 62A, 62B preferably is in its retracted condition. When the packer ram assemblies 62A, 62B are in their respective retracted conditions, each of the ram faces 66A, 66B is located proximal to the predetermined locations 61A, 61B respectively. Specifically, when the right side and left side packer ram assemblies 62A, 62B are in their respective retracted conditions, the ram faces 66A, 66B thereof preferably are positioned to push the waste material at the predetermined locations 61A, 61B in the right side waste stream and left side waste stream lower hopper compartments 60A, 60B toward the output ends 28A, 28B of the right side and left side bodies 22A, 22B.

In practice, this means that, when the right side and left side packer ram assemblies 62A, 62B are in their respective retracted conditions, the ram faces 66A, 66B preferably are positioned between the respective predetermined locations 61A, 61B and a cab assembly 68 that is positioned generally at a front end 70 of the vehicle 20 (FIG. 5).

The waste material discharged from the carts 40A, 40B into the right side waste stream and left side waste stream chutes 58A, 58B falls therefrom or therethrough into the right side waste stream and left side waste stream lower hopper compartments 60A, 60B at, or substantially at, the predetermined locations 61A, 61B. The waste material preferably is then pushed by the respective right side and left side packer ram assemblies 62A, 62B from the right side waste stream and left side waste stream lower hopper compartments 60A, 60B, through the right and left intake openings 30A, 30B, and into the right and left body compartments 24A, 24B, toward the right and left output openings 31A, 31B, i.e., in the directions generally indicated by arrows “WSA₂” and “WSB₂” (FIG. 3B).

Those skilled in the art would appreciate that this process is repeated at each intake location at which both of the carts 40A, 40B holding the waste material are initially discharged into the right side waste stream and left side waste stream chutes 58A, 58B. The process is repeated until one or both of the right and left body compartments 24A, 24B is in a filled condition, as will be described. It will be understood that on the route taken by the vehicle, the right side waste carts 40A consistently hold a first (preselected) type of waste material, and the left side waste carts 40B consistently hold a second (preselected) type of waste material. For instance, all the right side waste carts 40A may hold refuse material, and all the left side waste carts 40B may hold plastic recyclables.

It will also be understood that the right side waste stream and left side waste stream lower hopper compartments 60A, 60B are separated from each other by right side and left side lower hopper compartment inner walls 65A, 65B.

As can be seen in FIG. 3A, the right and left body compartments 24A, 24B are partially defined by respective right side and left side inner walls 76A, 76B and respective right side and left side outer walls 78A, 78B. Those skilled in the art would appreciate that the right side lower hopper compartment inner wall 65A is substantially aligned with the right side inner wall 76A, and the left side lower hopper compartment inner wall 65B is substantially aligned with the left side inner wall 76B, when the right side and left side bodies 22A, 22B are in their respective lowered positions.

The right and left body compartments 24B, 24B preferably are also partially defined by right side and left side body compartment floors 80A, 80B (FIG. 3A). Preferably, when the right side and left side bodies 22A, 22B are in their respective lowered positions, the right side and left side body compartment floors 80A, 80B are aligned with respective floors 82A, 82B of the right side waste stream and left side waste stream lower hopper compartments 60A, 60B (FIGS. 3A, 6A).

From the foregoing, it can be seen that the right side body compartment 24A is defined along its length by the inner and outer walls 76A, 78A and the floor 80A. The left side body compartment is defined along its length by the inner and outer walls 76B, 78B and the floor 80B. The right and left body compartments 24A, 24B are separated from each other along their entire lengths accordingly.

Preferably, a right side lower hopper compartment 60A is partially defined by a right side lower hopper compartment outer wall 67A, and a left side lower hopper compartment 60B is partially defined by a left side lower hopper compartment outer wall 67B (FIGS. 3E, 3F).

As can be seen in FIG. 3A, the right side and left side outer walls 78A, 78B extend between respective intake ends thereof 84A, 84B and respective output ends 86A, 86B. In one embodiment, the right side and left side outer walls 78A, 78B are not parallel to the right side and left side inner walls 76A, 76B. Instead, it is preferred that the right side and left side outer walls 78A, 78B diverge from the right side and left side inner walls from the intake ends 26A, 26B toward the output ends 28A, 28B, to provide for an increased capacity (i.e., larger cross-section) in the right and left body compartments 24A, 24B toward the respective output ends 28A, 28B, to allow for easier discharging of waste material.

Preferably, the right side and left side lower hopper compartment outer walls 67A, 67B are aligned with the right side and left side outer walls 78A, 78B respectively at the intake ends 84A, 84B thereof (FIG. 3E).

In use, until the right and left body ccompartments 24A, 24B are filled, the vehicle 20 is moved from one intake location to the next, and at each such location, the waste material in the carts 40A, 40B is discharged into the right side waste stream and left side waste stream chutes 58A, 58B. The waste material falls from or through the right side waste stream and left side waste stream chutes 58A, 58B into the right side and left side lower hopper compartments 60A, 60B, and from time to time, an operator (not shown) activates one or both of the packer ram assemblies 62A, 62B as required, to push the waste material in the right side and left side lower hopper compartments 60A, 60B and in the right and left body compartments 24A, 24B toward the output ends 28A, 28B. For instance, at each intake location, the operator may activate the right side and left side packer ram assemblies 62A, 62B after waste material is discharged from each of the carts 40A, 40B into the right side waste stream and left side waste stream chutes 58A, 58B respectively.

It will also be understood that, in use, as the right side and left side packer ram assemblies 62A, 62B repeatedly push the waste material of the right side and left side waste streams toward the respective output ends 28A, 28B, the waste material is compressed, and eventually accumulates in the right and left body compartments 24A, 24B respectively. When activated, the right side and left side packer ram assemblies 62A, 62B preferably compress the material in the right and left body compartments 24A, 24B, pressing the waste material therein against the closed right side and left side tailgate assemblies 33A, 33B respectively, until one (or both) of the right side and left side packer ram assemblies 62A, 62B is in a “stall out” condition.

Those skilled in the art would appreciate that the “stall out” condition is reached upon the pressure of the hydraulic fluid in one of the packer ram assemblies 62A, 62B exceeding a relief pressure thereof.

When one of the packer ram assemblies 62A, 62B is in a stall out condition, that packer ram assembly is unable to compress further the waste material in the right or left body compartment 24A, 24B, as the case may be.

Accordingly, when the right side packer ram assembly 62A “stalls out”, the right side body compartment 24A is considered to be in a filled condition. Similarly, when the left side packer ram assembly 62B “stalls out”, the left side body compartment 24B is considered to be in a filled condition. Upon one of the right side and left side packer ram assemblies 62A, 62B stalling out, this signals or indicates that the right or left body compartment 24A, 24B (as the case may be) is in a filled condition.

Those skilled in the art would also appreciate that, in one embodiment, upon one or both of the packer ram assemblies 62A, 62B stalling out, a signal may be generated, to alert the operator that a filled condition exists. The signal may be any suitable signal, e.g., an audible signal and/or a visual signal, and/or an electronically transmitted message. Alternatively, in the absence of an automatically generated signal, the operator may simply observe that stalling out has occurred for one of the packer ram assemblies, and proceed accordingly.

In one embodiment, upon the right side packer ram assembly 62A signalling that the right side body compartment 24A is in the filled condition, the right intake door assembly 32A preferably is activated to close the right intake opening 30A. Similarly, upon the left side packer ram assembly 62B signalling that the left side body compartment 24B is in a filled condition, the left intake door assembly 32B preferably is activated to close the left intake opening 30B. As will be described, to allow the right side and left side intake door assemblies 32A, 32B to close, the right side and left side packer ram assemblies 62A, 62B are moved to their retracted conditions.

Upon one or both of the right and left body compartments 24A, 24B being in a filled condition, the right side and left side packer ram assemblies 62A, 62B preferably are moved to their respective retracted conditions. Preferably, the operator causes the packer ram assemblies 62A, 62B to be in their retracted conditions when one has stalled out.

Once both of the packer ram assemblies 62A, 62B are moved to the retracted condition, the right side and left side intake door assemblies 32A, 32B are moved to their closed conditions. To move to the closed conditions thereof, right side and left side doors 72A, 72B are brought down, to close the intake openings 30A, 30B (FIGS. 6B, 7A). It will be understood that the intake door assemblies 32A, 32B preferably include means 73A, 73B for moving the doors 72A, 72B respectively between raised and lowered positions thereof (FIG. 3D). When the doors 72A, 72B are in their raised positions, the intake openings 30A, 30B are open, and when the doors 72A, 72B are lowered, the openings 30A, 30B are closed.

In one embodiment, each of the right side and left side intake door assemblies 32A, 32B preferably includes an interlock sensor subassembly 74A, 74B (FIG. 3D). It will be understood that the interlock sensor subassemblies 74A, 74B are only schematically represented in FIG. 3D. The interlock sensor subassemblies 74A, 74B are configured to prevent the right side and left side intake door assemblies 32A, 32B from moving to their closed conditions if the right side and left side packer ram assemblies 62A, 62B are in their extended conditions respectively. Because interlock devices are well known in the art, further description thereof is unnecessary.

Once the doors 72A, 72B are closed, the vehicle 20 is then moved to the disposal site. As noted above, at the disposal site, the vehicle is positioned, first to discharge the waste material in one of the body compartments at the location selected for receiving such waste material, and next, to discharge the waste material in the other body compartment at the location selected for receiving such waste material.

It will be understood that the right side and left side waste stream channels 38A, 38B may have any suitable relative proportions, e.g., they may have approximately the same volume, or any other suitable proportions.

The right and left hopper compartments 36A, 36B are separated from each other along their respective lengths, and the right and left body compartments 24A, 24B are also separated from each other along their respective lengths. From the foregoing, it can be seen that the waste material discharged into the right side and left side waste stream channels 38A, 38B is kept separate from the material discharge into the other waste stream channel from the point at which the waste material is discharged into the right side and left side waste stream channels 38A, 38B (i.e., initially into the right side waste stream and left side waste stream chutes 58A, 58B) until the waste material exits from the right side and left side waste stream channels 38A, 38B (i.e., at the output ends 28A, 28B).

From the foregoing, and as can be seen in FIGS. 7A and 7B, in order to substantially empty the respective left and right channels 38A, 38B, only one side body is raised to a raised position at a time, and subsequently lowered to a lowered position. For example, the left side body may be raised, to substantially empty the left side channel.

As noted above, only one of the left side and right side bodies 22A, 22B can be raised at any one time. After the left side channel has been substantially emptied, and the left side body 22B has been lowered to its lowered position, the right side body 22A may be raised to its raised position, to substantially empty the right side channel. After it has been substantially emptied, the right side body 22A is lowered to its lowered position.

As can be seen, for instance, in FIGS. 7A and 7B, the hopper 34 of the waste collection vehicle 20 is not required to be raised in order to allow the waste to be emptied from the right side body 22A and/or from the left side body 22B. Also, only one of the two bodies is raised at any one time. As a result, the peak energy consumed when the vehicle's body portions are emptied is substantially less than the peak energy consumed in a conventional waste collection vehicle. Regardless of how the waste collection vehicle 20 is powered, this means that its energy utilization is more efficient. It is believed that the waste collection vehicle 20, if outfitted as an electric vehicle, would have sufficient range for conventional waste collection routes.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

We claim:

1. A waste collection vehicle for collection of right side and left side waste streams that respectively include right side and left side waste stream material, the waste collection vehicle comprising:
a right side body mounted to a frame and movable between raised and lowered positions thereof, the right side body defining a right side body compartment extending between right intake and right output ends thereof, the right side body defining a right intake opening at the right intake end and a right output opening at the right output end;
a left side body mounted to the frame and movable between raised and lowered positions thereof, the left side body defining a left side body compartment extending between left intake and left output ends thereof, the left side body defining a left intake opening at the left intake end and a left output opening at the left output end;
a right intake door assembly, for closing and opening the right intake opening;
a right tailgate assembly, for closing and opening the right output opening;
a left intake door assembly, for closing and opening the left intake opening;
a left tailgate assembly, for closing and opening the left output opening; and
a hopper defining right and left hopper compartments therein, wherein the right hopper compartment and the right side body compartment define a right side waste stream channel to receive the right side waste stream when the right side body is in the lowered position thereof and the right intake opening is open, and the left hopper compartment and the left side body compartment define a left side waste stream channel to receive the left side waste stream when the left side body is in the lowered position thereof and the left intake opening is open,
wherein the right side and left side waste stream channels are sealed from each other, preventing cross-contamination of the right side and left side waste stream material.

2. The waste collection vehicle according to claim 1 additionally comprising:
a right side packer ram assembly, for pushing the right side waste stream material at least partially through the right side waste stream channel toward the right output end; and
a left side packer ram assembly, for pushing the left side waste stream material at least partially through the left side waste stream channel toward the left output end.

3. The waste collection vehicle according to claim 2 additionally comprising a cart tipper for lifting a right side waste cart and a left side waste cart with right side and left side waste stream material therein to respective discharge positions at which the right side and left side waste stream material is discharged from the right side and left side waste carts into the right side and left side waste stream channels respectively under the influence of gravity.

4. The waste collection vehicle according to claim 2 in which, upon the right side packer ram assembly signaling that the right side body compartment is in a filled condition, the right intake door assembly is activated to close the right intake opening, and the right side body is movable to its raised position, for evacuation of the right side waste stream material that is located in the right side body compartment.

5. The waste collection vehicle according to claim 2 in which, upon the left side packer ram assembly signaling that the left side body compartment is in a filled condition, the left intake door assembly is activated to close the left intake opening, and the left side body is movable to its raised position, for evacuation of the second waste stream material that is located in the left side body compartment.
